(19) United States
(12) Patent Application Publication
(10) Pub. No.: US 2026/0291985 A1
(43) Pub. Date: Sep. 24, 2026

(54) SPLIT-LAYER DEFENSE SYSTEM FOR VOLUMETRIC ATTACKS USING PROGRAMMABLE DATA PLANES

(71) Applicant: The Trustees of Princeton University, Princeton, NJ (US)

(72) Inventors: Sophia Yoo, Schwenksville, PA (US); Xiaoqi Chen, West Lafayette, IN (US); Jennifer Rexford, Princeton, NJ (US)

(73) Assignee: The Trustees of Princeton University, Princeton, NJ (US)

(21) Appl. No.: 19/576,657

(22) Filed: Mar. 24, 2026

Related U.S. Application Data
(60) Provisional application No. 63/776,681, filed on Mar. 24, 2025.

(51) Int. Cl. H04L 9/40

(52) U.S. Cl. CPC H04L 63/1458; H04L 63/1416

(57) ABSTRACT

The present disclosure provides a method for defending large-scale volumetric attacks in a scalable and performant manner. The method includes, on a first programmable target, performing a cookie check securely and tracking verified connections approximately, where programmable switches operably couple an unsecure network to a backbone network. The method further includes, on a device on the backbone network, using a second programmable target handling benign connections, conducting sequence number translations, and exactly tracking verified connections. A system for defending large-scale volumetric attacks includes a switch agent deployed on a first programmable target in a core network of an internet service provider, configured to perform a cookie check securely and track verified connections approximately, and a server agent deployed on a server on the core network configured to handle benign connections, conduct sequence number translations, and exactly track verified connections using a second programmable target.

### CROSS-REFERENCE TO RELATED APPLICATIONS

This application claims priority to U.S. Application No. 63/776,681, titled “Split-Layer Defense Against Volumetric Attacks with Programmable Data Planes”, filed Mar. 24, 2025, which is hereby incorporated by reference in its entirety.

### TECHNIÓCAL FIELD

The present disclosure relates to network security systems, and more particularly to a split-layer defense mechanism against volumetric attacks utilizing programmable data planes.

### BACKGROUND

Network infrastructure faces ongoing challenges from various types of cyberattacks that aim to disrupt services and compromise system availability. Among these threats, volumetric attacks represent a category of distributed denial-of-service (DDoS) attacks that attempt to overwhelm network resources by flooding them with massive amounts of traffic. These attacks can consume bandwidth, exhaust processing capacity, and render services unavailable to legitimate users.

Traditional approaches to defending against volumetric attacks have relied on software-based solutions running on general-purpose processors. While such approaches offer flexibility in implementing detection and mitigation logic, they may face limitations when processing high volumes of network traffic at line rate. As network speeds continue to increase, software-based defenses may struggle to keep pace with the throughput demands of modern network environments.

Programmable data planes have emerged as a technology that enables packet processing logic to be implemented directly in network hardware, such as switches and network interface cards. These programmable devices can process packets at high speeds while allowing network operators to customize forwarding behavior. However, programmable data planes typically have constraints on the complexity of operations that can be performed and the amount of state that can be maintained within the data plane itself.

Defense mechanisms against volumetric attacks may involve multiple stages of processing, including traffic analysis, attack detection, and mitigation actions. Distributing these functions across different layers of a network architecture presents various design considerations, including how to balance processing load, maintain detection accuracy, and minimize latency in responding to attacks.

Accordingly, there exists room for improvement in systems and methods for defending against volumetric attacks in network environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for defending large-scale volumetric attacks in a scalable and performant manner may be provided. The method may include, on a first programmable target, performing a cookie check securely, and tracking verified connections approximately. The first programmable target (e.g., programmable switches) may operably couple an unsecure network to a backbone network. The method may further include, on a device on the backbone network, using a second programmable target for handling benign connections, conducting sequence number translations, and exactly tracking verified connections.

According to other aspects of the present disclosure, the method may include one or more of the following features. The first programmable target may be a programmable switch. The second programmable target may be extended Berkeley Packet Filter (eBPF) kernel optimizations, a Smart NIC, or a FPGA NIC. The large-scale volumetric attacks may include distributed denial-of-service (DDoS) attacks. The DDoS attacks may be SYN flooding attacks. The large-scale volumetric attacks may include TCP-based attacks. The method may further include directly forwarding, without buffering, the final ACK packet of a TCP three-way handshake to the device on the backbone network, where the TCP three-way handshake may be between a client and the programmable switch. Forwarding the final ACK packet may include sending an additional setup tag in a setup packet to notify the device on the backbone network to bootstrap the connection setup. The setup packet may also instruct the device on the backbone network how to handle a difference in initial sequence numbers (ISNs) chosen by the programmable switch and a network stack of the device on the backbone network. The device on the backbone network may be a server. Tracking verified connections approximately may include using a Bloom filter to approximately keep track of clients that have passed the cookie check and successfully established a connection with the device on the backbone network. The device on the backbone network may deploy an eBPF ingress and egress program attached to different kernel hooks performing connection setup with the kernel network stack and sequence number translations on incoming and outgoing packets, using eBPF maps.

According to another aspect of the present disclosure, a system for defending large-scale volumetric attacks in a scalable and performant manner may be provided. The system may include a switch agent deployed on a first programmable target deployed in a core network of an internet service provider (ISP). The switch agent may be configured to perform a cookie check securely, and track verified connections approximately. The system may further include a server agent deployed on a server on the core network. The server agent may be configured to, using a second programmable target, handle benign connections, conduct sequence number translations, and exactly track verified connections.

According to other aspects of the present disclosure, the system may include one or more of the following features. The first programmable target may be a programmable switch. The second programmable target may be extended Berkeley Packet Filter (eBPF) kernel optimizations, a Smart NIC, or a FPGA NIC. The server agent may be deployed on a network interface card (NIC) or on a processing unit of a server. The system may further include one or more verified clients communicating with the server agent through the switch agent to communicate with an application running on the server wherein the server agent may be deployed on a network interface card (NIC) or on a processing unit of a server.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a split-proxy architecture for defending against volumetric attacks in a network environment.

FIG. 2 depicts a diagram illustrating HalfSipHash-2-4, which is used to compute and verify cookies, which requires 2 compression rounds on each input word w and 4 finalization rounds at the end, with each round costing 14 operations.

FIG. 3 illustrates an end-to-end diagram representing a connection establishment process in a split-proxy architecture.

FIG. 4 depicts a bar chart comparing maximum attack rates across different defense implementations.

FIG. 5 depicts a graph showing average end-to-end latency as a function of attack rate.

FIG. 6 depicts a graph showing CPU usage versus attack rate for different defense mechanisms.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Aspects of the present disclosure provide several technical advantages for defending against volumetric attacks in network environments. By distributing defense functions between a programmable switch at the network edge and a server agent on the backbone network, the split-layer architecture enables high-throughput packet processing while maintaining accurate connection tracking. The use of programmable data planes for performing cookie checks at line rate allows the system to filter malicious traffic before it reaches protected servers, thereby reducing the processing burden on server-side resources. Additionally, the approximate tracking of verified connections using space-efficient data structures at the switch level, combined with exact tracking at the server level, provides a balance between memory constraints in programmable hardware and the accuracy requirements for connection management. The sequence number translation mechanism enables seamless integration with existing TCP stacks without requiring modifications to client or server applications.

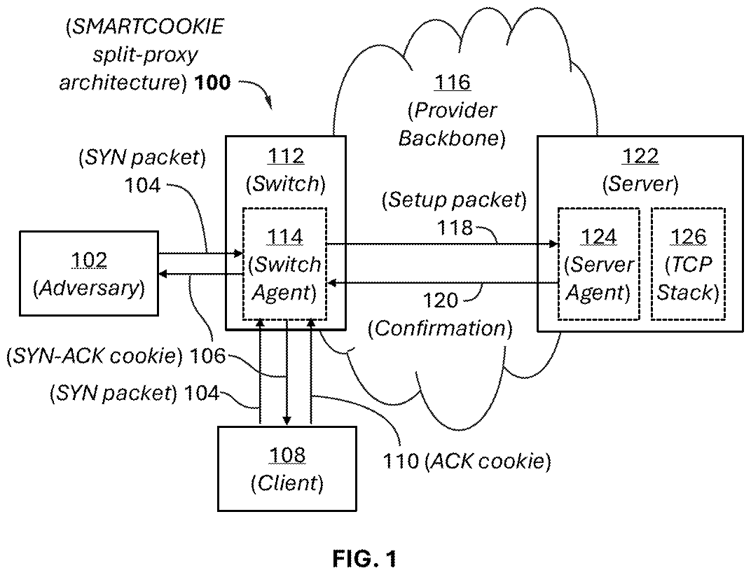

Referring to FIG. 1, a SMARTCOOKIE split-proxy architecture 100 provides a system for defending large-scale volumetric attacks in a scalable and performant manner. The SMARTCOOKIE split-proxy architecture 100 distributes defense functions across multiple network locations to enable protection against malicious traffic while permitting legitimate connections to proceed through the network.

The SMARTCOOKIE split-proxy architecture 100 includes a switch 112 positioned between an unsecure network and a provider backbone 116. The switch 112 contains a switch agent 114 that operates as a first line of defense against volumetric attacks. The switch agent 114 may be deployed on a first programmable target deployed in a core network of an internet service provider (ISP). The first programmable target may be a programmable switch capable of executing packet processing logic at line rate.

With continued reference to FIG. 1, the provider backbone 116 serves as a communication pathway connecting the switch 112 to a server 122 on a secure side of the network. The server 122 contains a server agent 124 and a TCP stack 126. The server agent 124 operates in conjunction with the TCP stack 126 to handle connection establishment and maintain communication with verified clients. The TCP stack 126 manages transport layer protocol operations for the server 122.

The arrangement of components in the SMARTCOOKIE split-proxy architecture 100 positions the switch 112 with the switch agent 114 at a network edge location where traffic from the unsecure network enters the provider backbone 116. The server 122 with the server agent 124 and the TCP stack 126 resides on the secure side of the provider backbone 116. This distribution of components between the switch agent 114 at the network edge and the server agent 124 at the server side enables the SMARTCOOKIE split-proxy architecture 100 to provide scalable protection against volumetric attacks while maintaining connectivity for verified clients attempting to reach applications running on the server 122.

The switch agent 114 may be deployed on a first programmable target such as a programmable switch. As described previously, the first programmable target may be a programmable switch capable of executing packet processing logic at line rate. The programmable switch provides a platform for the switch agent 114 to process incoming packets and perform defense operations against volumetric attacks at the network edge.

The switch agent 114 is configured to perform a cookie check securely.

Securely checking the cookies may be understood as validating the request's and/or the cookie's authenticity, integrity, and/or scope using, e.g., cryptographic signing, constant-time comparison, and proper cookie attribute flags, while ensuring transport-layer protection, such that an attacker cannot, e.g., forge, steal, replay, or tamper with the cookie, or the cookie-checking process, to gain unauthorized access. The cookie check may involve a challenge-response mechanism that distinguishes legitimate connection requests from malicious traffic. When a SYN packet 104 arrives at the switch 112, the switch agent 114 processes the SYN packet 104 and generates a response containing cryptographic information that a legitimate sender can use to prove the validity of the connection request.

An adversary 102 may send a SYN packet 104 toward the switch 112 in an attempt to initiate a connection. Similarly, a client 108 may send a SYN packet 104 to the switch 112 to establish a legitimate connection. The switch agent 114 responds to both the adversary 102 and the client 108 with a SYN-ACK cookie 106. The SYN-ACK cookie 106 contains encoded information that the switch agent 114 uses to verify subsequent responses without maintaining per-connection state for unverified connection attempts.

The client 108, being a legitimate entity, responds with an ACK cookie 110 back to the switch 112. The ACK cookie 110 contains information derived from the SYN-ACK cookie 106 that allows the switch agent 114 to verify that the client 108 received the SYN-ACK cookie 106 and is capable of completing the connection handshake. The switch agent 114 verifies the ACK cookie 110 by recomputing the expected cookie value and comparing the recomputed value against the received ACK cookie (e.g., ACK cookie 110).

The adversary 102, in contrast, may not provide a valid ACK cookie (e.g., ACK cookie 110) response. The adversary 102 may be unable to respond with a valid ACK cookie (e.g., ACK cookie 110) because the adversary 102 may use spoofed source addresses or may not implement the protocol correctly. By requiring a valid ACK cookie (e.g., ACK cookie 110) before proceeding with connection establishment, the switch agent 114 filters out connection attempts from sources that cannot complete the cookie verification process.

The switch agent 114 is configured to track verified connections approximately. Approximate tracking of verified connections allows the switch agent 114 to maintain information about connections that have passed the cookie check without storing complete per-connection state information. The switch agent 114 may use space-efficient probabilistic data structures to track verified connections approximately while operating within the memory constraints of programmable switch hardware.

Upon successful verification of the ACK cookie 110 from the client 108, the switch agent 114 forwards a setup packet 118 through the provider backbone 116 to the server 122. The setup packet 118 notifies the server agent 124 that a verified client (e.g., client 108) has completed the cookie verification process and is ready to establish a connection with the server 122. The setup packet 118 carries information that enables the server agent 124 to coordinate with the TCP stack 126 for connection establishment.

The server 122 sends a confirmation 120 back through the provider backbone 116 to the switch 112 upon receiving and processing the setup packet 118. The confirmation 120 indicates that the server agent 124 has received the setup packet 118 and has initiated the connection setup process with the TCP stack 126. Upon receiving the confirmation 120, the switch agent 114 may update the approximate tracking data structure to record that the connection between the client 108 and the server 122 has been established.

The approximate tracking mechanism employed by the switch agent 114 enables the switch 112 to process subsequent packets from verified clients without repeating the cookie verification process for each packet. When packets arrive at the switch 112 from a source that has previously completed the cookie verification and connection establishment process, the switch agent 114 may consult the approximate tracking data structure to determine whether to forward the packets through the provider backbone 116 to the server 122. The approximate nature of the tracking allows the switch agent 114 to operate with reduced memory requirements compared to exact per-connection state tracking, which may be advantageous given the limited memory resources available in programmable switch hardware.

The server agent 124 is deployed on the server 122 on the core network. As described previously, the server 122 resides on the secure side of the provider backbone 116 and contains the server agent 124 along with the TCP stack 126. The server agent 124 operates in coordination with the switch agent 114 to provide distributed defense against volumetric attacks while enabling legitimate connections to reach applications running on the server 122.

The server agent 124 is configured to, using a second programmable target, handle benign connections. The second programmable target provides a platform for the server agent 124 to perform packet processing operations at high throughput rates while maintaining compatibility with the TCP stack 126 on the server 122. The second programmable target enables the server agent 124 to intercept and process network traffic before the traffic reaches the TCP stack 126, allowing the server agent 124 to perform connection management and packet transformation operations.

The second programmable target may be an extended Berkeley Packet Filter (eBPF) kernel optimizations, Smart NIC, or FPGA NIC. When the second programmable target comprises eBPF kernel optimizations, the server agent 124 may execute packet processing logic within the operating system kernel of the server 122. The eBPF kernel optimizations provide a mechanism for attaching custom packet processing programs to various points in the kernel network stack, enabling the server agent 124 to intercept packets at ingress and egress stages. When the second programmable target comprises a Smart NIC, the server agent 124 may execute packet processing logic on a programmable network interface card that offloads processing from the main processor of the server 122. When the second programmable target comprises an FPGA NIC, the server agent 124 may execute packet processing logic on field-programmable gate array hardware integrated into a network interface card, providing hardware-accelerated packet processing capabilities.

The server agent 124 may be deployed on a network interface card (NIC) or on a processing unit of the server 122. When the server agent 124 is deployed on a network interface card, the server agent 124 executes on hardware resources provided by the network interface card, which may include dedicated processors, memory, and programmable logic elements. Deployment on a network interface card allows the server agent 124 to process packets before the packets are transferred to the main memory of the server 122, reducing the processing burden on the main processor of the server 122. When the server agent 124 is deployed on a processing unit of the server 122, the server agent 124 executes on the main processor or a co-processor of the server 122. Deployment on a processing unit of the server 122 allows the server agent 124 to leverage the computational resources of the server 122 while utilizing kernel-level packet processing mechanisms such as eBPF to achieve high-throughput packet processing.

The selection of deployment location for the server agent 124 may depend on the hardware capabilities of the server 122 and the performance requirements of the deployment environment. Deployment on a Smart NIC or FPGA NIC may provide higher packet processing throughput by offloading operations from the main processor, while deployment using eBPF kernel optimizations on the processing unit of the server 122 may provide flexibility in environments where specialized network interface hardware is not available.

The server agent 124 is configured to conduct sequence number translations. Sequence number translation involves modifying the sequence numbers and acknowledgment numbers in TCP packet headers to account for differences between the initial sequence numbers used by the switch agent 114 during the cookie-based handshake and the initial sequence numbers chosen by the TCP stack 126 during connection establishment with the server agent 124. When the switch agent 114 completes the cookie verification process with a client, the switch agent 114 uses a cookie value as the initial sequence number in the SYN-ACK cookie 106 sent to the client. When the server agent 124 subsequently establishes a connection with the TCP stack 126, the TCP stack 126 selects a different initial sequence number according to standard TCP behavior. The server agent 124 maintains a record of the difference between these two initial sequence numbers and applies translations to incoming and outgoing packets to ensure that the client and the TCP stack 126 can communicate correctly despite the sequence number mismatch.

The sequence number translation process involves the server agent 124 intercepting packets traveling between the client and the TCP stack 126. For packets arriving from the client through the switch agent 114, the server agent 124 may adjust the acknowledgment number field to reflect the sequence number space expected by the TCP stack 126. For packets departing from the TCP stack 126 toward the client, the server agent 124 may adjust the sequence number field to reflect the sequence number space expected by the client. The server agent 124 performs these translations transparently so that neither the client nor the TCP stack 126 requires modification to accommodate the split-proxy architecture.

The server agent 124 is configured to exactly track verified connections. Exact tracking of verified connections involves the server agent 124 maintaining complete per-connection state information for each connection that has been established through the split-proxy architecture. Unlike the approximate tracking performed by the switch agent 114, which may use probabilistic data structures with potential for false positives, the exact tracking performed by the server agent 124 maintains accurate records of each verified connection. The server agent 124 stores connection state information including the sequence number translation delta, connection identifiers, and connection status for each verified connection.

The exact tracking capability of the server agent 124 enables the server agent 124 to perform accurate sequence number translations for each packet belonging to a verified connection. The server agent 124 may store the sequence number translation information in data structures that allow efficient lookup based on connection identifiers such as source address, destination address, source port, and destination port. When a packet arrives at the server agent 124, the server agent 124 may look up the connection state to retrieve the appropriate sequence number translation delta and apply the translation before forwarding the packet to the TCP stack 126 or to the client through the switch agent 114.

The server agent 124 coordinates with the TCP stack 126 to establish connections. As described previously, the server agent 124 operates in conjunction with the TCP stack 126 to handle connection establishment and maintain communication with verified clients. When the server agent 124 receives a setup packet 118 from the switch agent 114 indicating that a client has completed the cookie verification process, the server agent 124 initiates a connection establishment procedure with the TCP stack 126. The server agent 124 may generate a SYN packet directed to the TCP stack 126 to begin a three-way handshake on behalf of the verified client. The TCP stack 126 responds with a SYN-ACK packet containing the initial sequence number chosen by the TCP stack 126. The server agent 124 completes the handshake with the TCP stack 126 by sending an ACK packet, thereby establishing a connection in the TCP stack 126 that corresponds to the verified client connection.

The server agent 124 maintains tracking of verified clients communicating through the switch agent 114. One or more verified clients may communicate with the server agent 124 through the switch agent 114 to communicate with an application running on the server 122. The verified clients are clients that have completed the cookie verification process with the switch agent 114 and have established connections through the split-proxy architecture. The server agent 124 tracks each verified client connection by maintaining state information that enables the server agent 124 to perform sequence number translations and route packets correctly between the verified clients and the TCP stack 126.

As described previously, the server agent 124 may be deployed on a network interface card (NIC) or on a processing unit of the server 122. The deployment location of the server agent 124 determines the mechanism by which the server agent 124 intercepts packets and performs sequence number translations. When deployed on a network interface card, the server agent 124 may perform sequence number translations in hardware or in firmware executing on the network interface card before packets reach the main memory of the server 122. When deployed on a processing unit of the server 122, the server agent 124 may perform sequence number translations using kernel-level packet processing mechanisms that intercept packets at ingress and egress points in the network stack.

A method for defending large-scale volumetric attacks in a scalable and performant manner includes operations distributed across multiple programmable targets positioned at different locations within a network infrastructure. The method comprises operations performed on a first programmable target and operations performed on a device on a backbone network using a second programmable target. The distribution of operations between the first programmable target and the second programmable target enables the method to address volumetric attacks while maintaining performance for legitimate network traffic.

The first programmable target operably couples an unsecure network to the backbone network. The first programmable target may be positioned at a network edge location where traffic from the unsecure network enters the backbone network. As described previously, the first programmable target may be a programmable switch. The programmable switch provides a platform for executing packet processing logic at line rate, enabling the first programmable target to process incoming packets and perform defense operations against volumetric attacks at the network edge. The programmable switch may be deployed in a core network of an internet service provider where the programmable switch can intercept traffic before the traffic reaches protected resources on the backbone network.

The device on the backbone network uses a second programmable target to perform operations that complement the operations performed on the first programmable target. As described previously, the second programmable target may be an extended Berkeley Packet Filter (eBPF) kernel optimizations, Smart NIC, or FPGA NIC. When the second programmable target comprises eBPF kernel optimizations, the device on the backbone network may execute packet processing logic within an operating system kernel. The eBPF kernel optimizations provide a mechanism for attaching custom packet processing programs to various points in a kernel network stack, enabling high-throughput packet processing without requiring modifications to the kernel itself. When the second programmable target comprises a Smart NIC, the device on the backbone network may execute packet processing logic on a programmable network interface card that offloads processing from a main processor. When the second programmable target comprises an FPGA NIC, the device on the backbone network may execute packet processing logic on field-programmable gate array hardware integrated into a network interface card, providing hardware-accelerated packet processing capabilities.

The method leverages the capabilities of both the first programmable target and the second programmable target to distribute defense functions across the network infrastructure. The first programmable target at the network edge handles initial traffic filtering and verification operations, while the second programmable target on the device on the backbone network handles connection management and packet transformation operations. This distribution of operations between the programmable targets enables the method to defend against large-scale volumetric attacks in a scalable and performant manner by processing attack traffic at the network edge before the attack traffic can consume resources on the backbone network.

The large-scale volumetric attacks that the method defends against include distributed denial-of-service (DDoS) attacks. DDoS attacks involve multiple sources sending traffic toward a target system with the intent of overwhelming the target system's capacity to process legitimate requests. The distributed nature of DDoS attacks makes defense challenging because the attack traffic originates from numerous sources, which may be geographically dispersed and may use spoofed source addresses to obscure the true origin of the attack traffic. The method addresses DDoS attacks by performing cookie verification at the first programmable target to filter out traffic from sources that cannot complete the verification process, thereby reducing the volume of attack traffic that reaches the device on the backbone network.

The DDoS attacks may be SYN flooding attacks. SYN flooding attacks exploit the TCP connection establishment mechanism by sending large volumes of SYN packets to a target system without completing the three-way handshake. When a target system receives a SYN packet, the target system allocates resources to track the pending connection and sends a SYN-ACK packet in response. In a SYN flooding attack, the attacker does not respond to the SYN-ACK packet with a valid ACK packet, causing the target system to maintain state for incomplete connections until timeout periods expire. By sending SYN packets at high rates, an attacker can exhaust the connection tracking resources of the target system, preventing the target system from accepting legitimate connection requests. The method defends against SYN flooding attacks by using the cookie-based verification mechanism at the first programmable target, which allows the first programmable target to respond to SYN packets without allocating per-connection state until a valid ACK response is received.

The large-scale volumetric attacks include TCP-based attacks. TCP-based attacks encompass a category of attacks that exploit various aspects of the TCP protocol to disrupt network services. In addition to SYN flooding attacks, TCP-based attacks may include ACK flooding attacks, RST flooding attacks, and other attacks that generate high volumes of TCP packets toward a target system. ACK flooding attacks involve sending large volumes of ACK packets to a target system, which may cause the target system to expend processing resources attempting to match the ACK packets to existing connections. The method defends against TCP-based attacks by distributing defense functions between the first programmable target at the network edge and the second programmable target on the device on the backbone network. The first programmable target performs cookie checks and approximate connection tracking to filter malicious TCP traffic, while the second programmable target handles benign connections and performs exact connection tracking to manage legitimate TCP traffic.

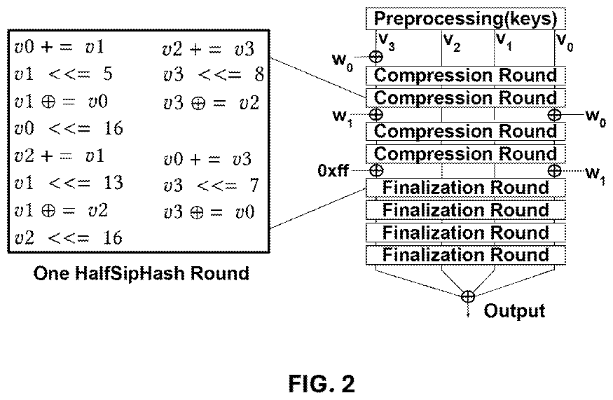

Referring to FIG. 2, the cookie check performed securely on the first programmable target involves a hash computation process that generates and verifies cookies used in the challenge-response mechanism. As described previously, the first programmable target may be a programmable switch that performs the cookie check to distinguish legitimate connection requests from malicious traffic. The hash computation process depicted in FIG. 2 illustrates a HalfSipHash round structure and the overall computation flow used to compute and verify cookies at line rate on the programmable switch.

The HalfSipHash computation operates on four state variables designated as v0, v1, v2, and v3. The left side of FIG. 2 depicts one HalfSipHash round showing a sequence of arithmetic and bitwise operations performed on the four state variables. The operations within each round include additions, left rotations by specified bit amounts, and XOR operations performed in a specific order to mix the state variables together. The mixing of state variables through these operations provides cryptographic properties that enable the cookie check to be performed securely.

With continued reference to FIG. 2, the right side of the figure shows the complete hash computation structure used for cookie generation and verification. The computation begins with a preprocessing stage that processes keys and initializes the four state variables v3, v2, v1, and v0. The preprocessing stage establishes the initial state of the hash computation based on secret key material, which enables the first programmable target to generate cookies that cannot be forged by an adversary without knowledge of the secret key.

The hash computation structure processes two input words designated as w0 and w1. The input word w0 is XORed with state variable v3 before a first compression round. The computation then proceeds through compression rounds that process the input data and mix the state variables. The input word w1 is XORed with state variable v3 before a third compression round. After the compression rounds complete, the value w0 is XORed with state variable v0 and the value w1 is XORed with state variable v0 as outputs from the compression phase.

Following the compression phase, a finalization constant with hexadecimal value 0xff is XORed with state variable v2. The computation then proceeds through four finalization rounds that further mix the state variables. The finalization rounds apply the same round operations depicted on the left side of FIG. 2 to produce the final hash output. After the finalization rounds complete, the output is produced by XORing together all four state variables v3, v2, v1, and v0.

The HalfSipHash-2-4 computation depicted in FIG. 2 may be used by the first programmable target to compute cookies when responding to SYN packets and to verify cookies when receiving ACK packets. When computing a cookie for a SYN-ACK response, the first programmable target may use connection parameters such as source address, destination address, source port, and destination port as input to the hash computation along with secret key material. The resulting hash output forms the cookie value embedded in the SYN-ACK packet. When verifying a cookie from an ACK packet, the first programmable target may recompute the expected cookie value using the same connection parameters and secret key material, then compare the recomputed value against the cookie value received in the ACK packet. A match indicates that the sender received the SYN-ACK packet and is capable of completing the connection handshake, thereby passing the cookie check.

The use of HalfSipHash-2-4 (or analogous approaches) for the cookie check provides a balance between computational efficiency and cryptographic security suitable for implementation on programmable switch hardware. The structure of the computation with two compression rounds and four finalization rounds enables the first programmable target to compute and verify cookies within the processing constraints of programmable data plane hardware while maintaining resistance against forgery attempts by adversaries.

Tracking verified connections approximately on the first programmable target enables the first programmable target to maintain information about connections that have passed the cookie check without storing complete per-connection state information for each verified connection. As described previously, the first programmable target may be a programmable switch positioned at a network edge location where traffic from an unsecure network enters a backbone network. The programmable switch operates under memory constraints that limit the amount of per-connection state information that can be stored. Approximate tracking addresses these memory constraints by using probabilistic data structures that provide space-efficient representations of connection state.

Tracking verified connections approximately includes using a Bloom filter to approximately keep track of clients that have passed the cookie check and successfully established a connection with the device on the backbone network. A Bloom filter is a probabilistic data structure that supports membership queries with a compact memory footprint. The Bloom filter uses multiple hash functions to map connection identifiers to positions in a bit array. When a client passes the cookie check and establishes a connection with the device on the backbone network, the first programmable target inserts the connection identifier into the Bloom filter by computing hash values and setting the corresponding bit positions in the bit array.

When subsequent packets arrive at the first programmable target from a source, the first programmable target may query the Bloom filter to determine whether the source has previously passed the cookie check and established a connection. The query operation involves computing the same hash values used during insertion and checking whether all corresponding bit positions in the bit array are set. If all bit positions are set, the Bloom filter indicates that the connection may be a verified connection, and the first programmable target may forward the packets toward the device on the backbone network without requiring the source to repeat the cookie verification process.

The Bloom filter provides approximate tracking because the Bloom filter may produce false positive results. A false positive occurs when the Bloom filter indicates that a connection identifier is present in the filter even though the connection identifier was not previously inserted. False positives arise because multiple connection identifiers may hash to overlapping bit positions in the bit array. The probability of false positives depends on the size of the bit array, the number of hash functions used, and the number of connection identifiers inserted into the Bloom filter. By selecting appropriate parameters for the Bloom filter, the first programmable target may achieve a desired balance between memory consumption and false positive probability.

The Bloom filter does not produce false negative results. When a connection identifier has been inserted into the Bloom filter, subsequent queries for that connection identifier return a positive result. This property ensures that verified connections are not incorrectly rejected by the first programmable target after passing the cookie check and establishing a connection with the device on the backbone network.

The use of a Bloom filter for approximate tracking enables the first programmable target to operate within the memory constraints of programmable switch hardware while maintaining the ability to distinguish between packets from verified connections and packets from unverified sources. The compact memory footprint of the Bloom filter allows the first programmable target to track a large number of verified connections using a fixed amount of memory. The approximate nature of the tracking is acceptable at the first programmable target because the device on the backbone network performs exact tracking of verified connections, as described previously, which provides accurate connection state information for sequence number translations and connection management operations.

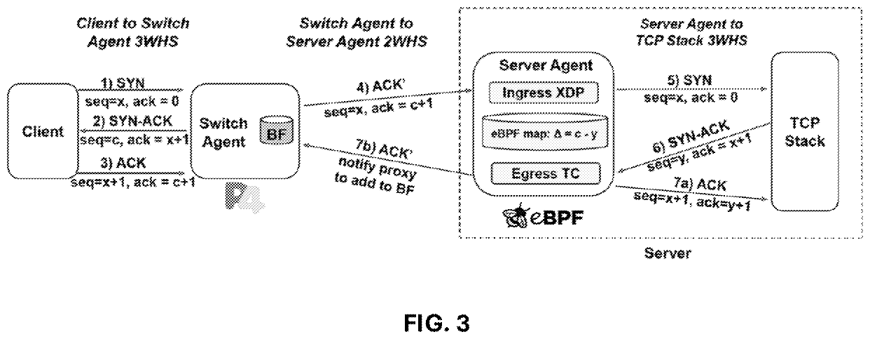

Referring to FIG. 3, a connection establishment process in the split-proxy architecture involves three distinct phases that coordinate interactions between a client, a switch agent, a server agent, and a TCP stack. The connection establishment process enables verified clients to establish connections with applications running on a server while the split-proxy architecture provides protection against volumetric attacks. FIG. 3 depicts a sequence diagram showing the message exchanges that occur during each phase of the connection establishment process.

The first phase of the connection establishment process comprises a client to switch agent three-way handshake. The client initiates the three-way handshake by sending a SYN packet to the switch agent. The SYN packet contains a sequence number designated as x and an acknowledgment number of 0, indicating that the client is requesting to establish a new connection. The switch agent, which may be implemented using P4 programming on a programmable switch, receives the SYN packet and responds with a SYN-ACK packet. The SYN-ACK packet contains a sequence number designated as c, which represents a cookie value computed by the switch agent, and an acknowledgment number of x+1, which acknowledges receipt of the client's SYN packet. The client completes the three-way handshake by sending an ACK packet with a sequence number of x+1 and an acknowledgment number of c+1. This ACK packet represents the final ACK packet of the TCP three-way handshake between the client and the programmable switch.

With continued reference to FIG. 3, the method includes directly forwarding, without buffering, the final ACK packet of the TCP three-way handshake to the device on the backbone network. As described previously, the TCP three-way handshake is between a client and the programmable switch. When the switch agent receives the final ACK packet from the client, the switch agent verifies the cookie value contained in the acknowledgment number field. Upon successful verification, the switch agent forwards the ACK packet directly to the server agent without storing the packet in a buffer. The direct forwarding approach avoids the memory overhead associated with buffering packets at the switch agent and enables the switch agent to process connection establishment requests at line rate.

The second phase of the connection establishment process comprises a switch agent to server agent two-way handshake. The switch agent forwards an ACK′ packet to the server agent with a sequence number of x and an acknowledgment number of c+1. The ACK′ packet notifies the server agent that a client has completed the cookie verification process with the switch agent and is ready to establish a connection. The server agent, which may utilize eBPF with ingress XDP and egress TC components, receives the ACK′ packet and prepares to establish a connection with the TCP stack on behalf of the verified client.

The server agent maintains an eBPF map that stores a delta value calculated as the difference between c and y, where c represents the initial sequence number chosen by the switch agent during the cookie-based handshake and y represents the initial sequence number that the TCP stack selects during connection establishment. The delta value enables the server agent to perform sequence number translations on subsequent packets traveling between the client and the TCP stack.

The third phase of the connection establishment process comprises a server agent to TCP stack three-way handshake. The server agent initiates a connection with the TCP stack by sending a SYN packet with a sequence number of x and an acknowledgment number of 0. The TCP stack responds with a SYN-ACK packet containing a sequence number designated as y and an acknowledgment number of x+1. The server agent completes the handshake with the TCP stack by sending an ACK packet with a sequence number of x+1 and an acknowledgment number of y+1. Upon completion of this three-way handshake, the TCP stack has established a connection that corresponds to the verified client connection.

Following the completion of the server-side handshake, the server agent sends an ACK′ packet back to the switch agent. The ACK′ packet notifies the switch agent to add the connection to a Bloom filter for approximate tracking of verified connections. As described previously, the Bloom filter enables the switch agent to track verified connections approximately while operating within the memory constraints of programmable switch hardware.

The eBPF map maintained by the server agent stores the delta value representing the difference between the initial sequence numbers chosen by the switch agent and the TCP stack. The server agent uses the delta value to perform sequence number translations for subsequent packets in the connection. For packets arriving from the client through the switch agent, the server agent adjusts the acknowledgment number field by subtracting the delta value before forwarding the packets to the TCP stack. For packets departing from the TCP stack toward the client, the server agent adjusts the sequence number field by adding the delta value before forwarding the packets through the switch agent to the client. The sequence number translations enable the client and the TCP stack to communicate correctly despite the difference in initial sequence numbers resulting from the split-proxy architecture.

Forwarding the final ACK packet of the TCP three-way handshake includes sending an additional setup tag in a setup packet to notify the device on the backbone network to bootstrap the connection setup. As described previously, when the switch agent receives the final ACK packet from a client and verifies the cookie value, the switch agent forwards information to the server agent to initiate connection establishment on the server side. The setup packet contains the additional setup tag that signals to the device on the backbone network that a new verified connection requires initialization. The additional setup tag may comprise a flag or identifier embedded within the setup packet that distinguishes the setup packet from regular data packets. Upon receiving the setup packet with the additional setup tag, the device on the backbone network recognizes that the packet represents a connection bootstrap request rather than ongoing connection traffic. The device on the backbone network responds to the additional setup tag by initiating the connection establishment procedure with the network stack, which involves generating a SYN packet directed to the network stack to begin a three-way handshake on behalf of the verified client.

The setup packet also instructs the device on the backbone network how to handle a difference in initial sequence numbers (ISNs) chosen by the programmable switch and a network stack of the device on the backbone network. As described previously, the programmable switch uses a cookie value as the initial sequence number during the cookie-based handshake with the client, while the network stack of the device on the backbone network selects a different initial sequence number according to standard TCP behavior when establishing the server-side connection. The setup packet carries information that enables the device on the backbone network to compute or determine the difference between these two initial sequence numbers. The setup packet may include the initial sequence number used by the programmable switch, the acknowledgment number received from the client, or other connection parameters that allow the device on the backbone network to calculate the sequence number delta. Upon receiving the setup packet, the device on the backbone network extracts the relevant sequence number information and stores the computed delta value for use in subsequent sequence number translations. The instructions conveyed by the setup packet enable the device on the backbone network to perform accurate sequence number translations on packets traveling between the client and the network stack, ensuring that both endpoints can communicate correctly despite the difference in initial sequence numbers resulting from the split-proxy architecture.

The device on the backbone network may be a server. As described previously, the server resides on a secure side of a provider backbone and contains a server agent along with a TCP stack. The server provides computational resources and network connectivity for hosting applications that clients access through the split-proxy architecture. When the device on the backbone network comprises a server, the server receives verified connection requests from a switch agent positioned at a network edge and establishes connections with the TCP stack to enable communication between verified clients and applications running on the server.

The device on the backbone network deploys an eBPF ingress and egress program attached to different kernel hooks performing connection setup with the kernel network stack and sequence number translations on incoming and outgoing packets, using eBPF maps. The eBPF ingress program attaches to an ingress kernel hook that intercepts packets arriving at the server before the packets reach the kernel network stack. The ingress kernel hook may comprise an eXpress Data Path (XDP) hook that provides early access to incoming packets at a point in the network stack where packets can be processed with minimal overhead. The eBPF egress program attaches to an egress kernel hook that intercepts packets departing from the kernel network stack before the packets are transmitted on the network. The egress kernel hook may comprise a Traffic Control (TC) hook that provides access to outgoing packets after the kernel network stack has processed the packets.

The eBPF ingress program performs connection setup with the kernel network stack when the server receives a setup packet indicating that a verified client has completed a cookie verification process with a switch agent. Upon receiving the setup packet, the eBPF ingress program initiates a three-way handshake with the kernel network stack on behalf of the verified client. The eBPF ingress program generates a SYN packet directed to the kernel network stack to begin the connection establishment procedure. The kernel network stack responds with a SYN-ACK packet containing an initial sequence number selected by the kernel network stack. The eBPF ingress program completes the handshake by sending an ACK packet to the kernel network stack, thereby establishing a connection in the kernel network stack that corresponds to the verified client connection.

The eBPF ingress program and the eBPF egress program perform sequence number translations on incoming and outgoing packets using eBPF maps. The eBPF maps provide a mechanism for storing and retrieving per-connection state information that persists across packet processing operations. The eBPF maps may comprise hash maps, arrays, or other data structures supported by the eBPF subsystem that enable efficient lookup of connection state based on connection identifiers such as source address, destination address, source port, and destination port.

The eBPF map maintains the delta value between initial sequence numbers. As described previously, the delta value represents the difference between the initial sequence number used by the switch agent during the cookie-based handshake with the client and the initial sequence number chosen by the kernel network stack during connection establishment. When the eBPF ingress program completes the three-way handshake with the kernel network stack, the eBPF ingress program computes the delta value by subtracting the initial sequence number from the kernel network stack from the initial sequence number used by the switch agent. The eBPF ingress program stores the computed delta value in the eBPF map, associating the delta value with the connection identifier for the verified client connection.

The eBPF ingress program performs sequence number translations on incoming packets by retrieving the delta value from the eBPF map and adjusting the acknowledgment number field in packet headers. When a packet arrives from a client through the switch agent, the eBPF ingress program extracts the connection identifier from the packet header and queries the eBPF map to retrieve the stored delta value. The eBPF ingress program subtracts the delta value from the acknowledgment number field in the packet header to translate the acknowledgment number from the sequence number space expected by the client to the sequence number space used by the kernel network stack. The eBPF ingress program then forwards the translated packet to the kernel network stack for processing.

The eBPF egress program performs sequence number translations on outgoing packets by retrieving the delta value from the eBPF map and adjusting the sequence number field in packet headers. When a packet departs from the kernel network stack toward a client, the eBPF egress program extracts the connection identifier from the packet header and queries the eBPF map to retrieve the stored delta value. The eBPF egress program adds the delta value to the sequence number field in the packet header to translate the sequence number from the sequence number space used by the kernel network stack to the sequence number space expected by the client. The eBPF egress program then forwards the translated packet toward the switch agent for transmission to the client.

On the device on the backbone network, using a second programmable target, the server handles benign connections. As described previously, the second programmable target may comprise eBPF kernel optimizations, a Smart NIC, or an FPGA NIC. When the second programmable target comprises eBPF kernel optimizations, the eBPF ingress and egress programs provide the mechanism for handling benign connections by performing connection setup with the kernel network stack and managing packet flow between verified clients and applications running on the server. The handling of benign connections involves accepting verified connection requests, establishing corresponding connections with the kernel network stack, and forwarding packets between clients and the kernel network stack with appropriate sequence number translations.

The device on the backbone network conducts sequence number translations as part of handling benign connections. As described previously, the sequence number translations involve modifying sequence numbers and acknowledgment numbers in TCP packet headers to account for differences between initial sequence numbers used by the switch agent and initial sequence numbers chosen by the kernel network stack. The eBPF ingress and egress programs perform these translations transparently so that neither the client nor the kernel network stack requires modification to accommodate the split-proxy architecture.

The device on the backbone network exactly tracks verified connections. As described previously, exact tracking of verified connections involves maintaining complete per-connection state information for each connection established through the split-proxy architecture. The eBPF maps provide the storage mechanism for exact tracking by maintaining accurate records of each verified connection, including the delta value for sequence number translations, connection identifiers, and connection status. The exact tracking capability enables the device on the backbone network to perform accurate sequence number translations for each packet belonging to a verified connection and to manage connection state throughout the lifetime of each connection.

### Example—SmartCookie

To overcome the challenges and existing limitations, SmartCookie proposes a novel split-proxy architecture. See FIG. 1.

At a high level, SMARTCOOKIE takes traditional SYN cookie defense elements, refactors them, splits them between a co-designed switch agent (running on the switch data plane) and server agent (running on the Linux kernel data plane), and stitches switch agent and server agent together with a collaborative protocol. There are three key elements of existing defenses: F1) SYN cookie checks, F2) TCP sequence number translations, and F3) keeping state for verified connections. The disclosed approach refactors and maps defense elements F1-F3 to switch and server as follows: SMARTCOOKIE switch agent securely performs cookie checks to quickly stop bad traffic (F1) and approximately tracks verified connections (F3.A) instead of keeping exact state, while SMARTCOOKIE server agent handles sequence number translations (F2) and exactly tracks verified connections (F3.B).

SMARTCOOKIE switch agent maintains approximate state using compact data structures with well-defined accuracy guarantees. Note that in contrast to prior work, the disclosed defense does not require exact state at the switch, but still achieves overall exact defense results, due to its split design.

Switch Agent. The SmartCookie switch agent performs cookie checks securely (F1) and tracks verified connections approximately (F3.A). This design is motivated by the underlying switch architecture, which is optimized for high-speed packet processing up to Tbps, an order of magnitude greater than the speeds of general-purpose CPUs. The switch agent is an ideal location for offloading of SYN cookie checks. It can securely and performantly block 100% of SYN floods, without burdening the server. Recall that to achieve high throughput and low latency, however, the switch only has a limited amount of memory, and memory accesses are constrained. Thus, the switch agent should not be required to remember all the connections that have successfully passed the cookie check. In other words, verified records should be kept in an approximate data structure at the switch agent.

Server Agent. Meanwhile, SmartCookie server agent is primarily responsible for handling benign connections, conducting sequence number translations (F2) and exactly tracking verified connections (F3.B). Servers offer greater compute flexibility and have fewer constraints on memory access and usage than switches. Thus, the server agent is ideal for maintaining exact information about verified connections and for performing sequence number translations on behalf of the switch agent. This offloading of unique per-connection sequence number translations is enabled by a special setup procedure, which the switch agent and server agent cooperatively perform using custom setup request and confirmation packets. The server agent's sequence number translation mechanism ensures consistent sequence number progression, preserves the correctness of the TCP protocol, and is transparent to unmodified end hosts. It is noted that the greater compute flexibility at the server agent comes at the cost of lower packetprocessing speeds as compared to hardware speeds, but this is a reasonable tradeoff since the amount of benign traffic the server agent must process is much smaller than the amount of attack traffic that the switch agent must identify and drop.

### Secure SYN Cookies in the Data Plane

SmartCookie switch agent is responsible for performantly computing and verifying SYN cookies in the data plane, but for any defense to be worthwhile, this must be done securely.

Choice of Hash Function. There are several potential choices of data-plane hash functions. Recall that because of the computational constraints of the switch, it is extremely challenging to compute a cryptographically secure hash function in the data plane. Hence, several prior works opted to use the CRC32 checksum as a “hash” function to compute SYN cookies, resulting in significant vulnerability. This is because an adaptive adversary can always send crafted SYN packets and observe the resulting cookies (i.e., a chosen-plaintext attack), efficiently solve and extract the key used in hashing, and then forge cookies for any 4-tuple, bypassing the defense entirely.

SmartCookie securely computes and verifies cookies using HalfSipHash-2-4, which is from the SipHash family of hashes used by Linux for computing SYN cookies. HalfSipHash-2-4 was also chosen for performance reasons, as it is faster than SipHash-2-4, while still sharing the same construction. It is believed HalfSipHash-2-4 with key rotation offers acceptable security against even well-provisioned adversaries (e.g., key brute-forcing adversaries), achieving good security along with lightweight performance. The hash is cryptographically robust and designed for speed on short inputs, making it ideal for computing cookies in the data plane, where the input to the hash is just a few bytes from the packet header.

Securely Computing Cookies. HalfSipHash is seeded by secret keys, used to initialize four internal variables v0-v3 (FIG. 2). The hash input gets mixed with these internal variables using arithmetic operations (Add, Shift, XOR) across several computational rounds. HalfSipHash-c-d performs c rounds of computation (compression rounds) for each w 32-bit word of the hash input. Once all input bytes have been processed by compression rounds, an additional d rounds of computation are performed, called finalization rounds. Finally, the four internal variables are XORed, giving the hash output.

Each round of computation requires 14 arithmetic operations, including six circular left shifts. Since most of the arithmetic operations directly use the output of the previous operation (FIG. 2), they create a long dependency chain. Since the P4 language does not natively support the circular shift operation, naively implementing a circular left shift of n bits requires three intermediate operations: a left shift of n bits, a right shift of 32-n bits, and then a bitwise OR of these two intermediate results. Because of the dependency chain between the bitwise OR and the intermediate shifts, calculating a single circular shift will require two pipeline stages, which quickly becomes unreasonably costly given the limited number of available stages in the switch.

Instead of using a multi-operation, multi-stage approach to circular bit shifts, one can optimize the computation by using a built-in slicing primitive on the switch to slice out the desired upper and lower bits of the variable. One can then use a supported concatenation primitive to stitch the newly relocated bits together in a new variable, fitting the full circular shift into one operation in a single pipeline stage. Additionally, one can optimize the number of pipeline stages needed for the computation, by manually grouping the 14 arithmetic operations in a round into 4 stages based on their dependencies.

Recirculation. To calculate cookies, one can operate HalfSipHash on a 16-byte (w=4 word) input, requiring in total 2w+4=12 compression and finalization rounds. Although this example has optimized HalfSipHash for modern switch hardware, several pipeline passes are still required to perform all the rounds. Hardware switches support a packet recirculation feature that allows for computation across multiple pipeline passes. It is noted that naively using just the ingress pipeline of the switch for computing the hash would require r=(2w+4)/2-1=w+1=5 recirculations. However, HalfSipHash can be integrated with SmartCookie's switch agent logic to run in both the ingress and egress pipelines, reducing r to (2w+4)/4-1=w/2=2 recirculations per hash.

In practice, network switches have dedicated recirculation ports, and additional ports can be reserved for recirculation. Dedicating additional ports for recirculation would reduce the bandwidth that could have been used for serving other traffic, but this is an acceptable performance tradeoff for the security gains of a robust hash. It is shown below that even with recirculations, a HalfSipHash-based switch agent returns secure cookies 2.6× faster than the next fastest defense. Additionally, the recirculation limitations of the prototype result from the lack of cryptographic building blocks in the network hardware, which can be improved in the future.

Key Rotation. To defend against brute-force attacks, HalfSipHash keys are rotated periodically (e.g., every 5-30 seconds). This reflects an underestimation of the time needed to brute-force a key. To ensure handshakes from clients are not accidentally blocked, cookies computed with an old key are still accepted for a short period after a key rotation.

### Split-Proxy Design

With a secure SYN cookie hash in the data plane, one can safely offload cookie checks to a high-speed switch. However, one must still tackle the challenge of limited switch memory for handling benign flows. SmartCookie accomplishes this with a split-proxy design, where a switch agent and server agent cooperate to performantly stop attack traffic and correctly handle benign traffic. The disclosed design avoids packet buffering during setup and bypasses sequence number translations at the switch agent, allowing it to approximately track verified connections and scale beyond available switch memory.

### Switch to Server Two-Way Handshake

FIG. 3 shows SmartCookie's complete setup procedure for verified connections. In packets 1-3 SmartCookie switch agent verifies clients by performing a secure SYN cookie check as in the traditional defense. However, under the SmartCookie protocol, the switch agent does not buffer the final ACK of the TCP three-way handshake (3 WHS) between the client and switch agent. Instead, the switch agent directly forwards this ACK packet to the SmartCookie server agent with an additional setup tag, notifying the server agent to bootstrap the connection setup (packet 4). The switch agent also uses this packet to instruct the server agent how to handle the difference in initial sequence numbers (ISNs) that were chosen by the switch agent and the server's network stack.

After receiving this tagged setup packet, the server agent sets up its side of the connection, shown with packets 5-7a. The server agent then sends a packet to the switch agent to confirm the connection establishment, completing the custom setup between switch agent and server agent as shown with packet 7b. Note that the server agent has been instructed by the switch agent how to handle sequence number deltas, so the client and server see their expected sequence numbers in both directions. This allows the switch agent to step into a passive forwarding role and avoid the expense of sequence number translations throughout the remainder of the connection.

SmartCookie converts the original 3WHS between switch and server into a custom two-way handshake (2 WHS) between switch agent and server agent, notifying the server of the client connection, because at this point the server is still unaware of the client. It is noted that a 3WHS between switch agent and server agent is undesirable, causing overhead at the switch for buffering packets from the client while the second 3WHS is being conducted. Additionally, even after the end-to-end connection is established, per-packet processing at the switch for sequence number translations is undesirable. Instead, by explicitly informing the server agent of the connection and sending information for sequence number translations, the switch agent can safely forward packets from a verified connection without additional processing.

Handling Setup Latency and Packet Drops. SmartCookie reliably handles more complex scenarios introduced by connection setup latency, reordered packets, or packet drops. Consider the scenario where the 2WHS between the switch agent and server agent is not yet complete, either because it is still in progress or because the setup packet sent to the server agent has been lost. If the client sends additional data packets to the server during this state, the SmartCOOKIE switch agent handles this gracefully by continuing to verify and tag these packets before forwarding them to the server agent (note that the switch agent never buffers client packets). Since the client has yet to receive any packets from the server, the server-side sequence numbers have not progressed and the client would still pass the cookie check at the switch agent. As long as the client's packets continue to pass the cookie check, the switch agent will tag and forward them to the server agent, and upon receipt of any tagged packet from the switch agent, the server agent will immediately set up the connection and send an explicit confirmation to the switch agent. Upon receiving this confirmation, the switch agent no longer tags any packets from the client and simply forwards packets in both directions.

### Redesigned Server Setup

SmartCookie uses eBPF to facilitate division of labor between switch and server agents. The disclosed design does not modify the network stack of end hosts, which is particularly beneficial for datacenter deployments where network operators may not control end host TCP behavior (e.g., tenant VMs).

eBPF Primer. eBPF (extended Berkeley Packet Filter) is a powerful and lightweight technology that allows for safe, fast, kernel-level execution of programs directly from userspace, without requiring programmers to rewrite kernel source code. The Linux networking community has been taking advantage of eBPF for efficient packet filtering and safe kernel-level execution in many different security applications, including in the DDoS space.

Modified TCP Interface. With eBPF, one can redesign the TCP interface between the network and the Linux kernel's network stack. This allows the system to offload connection setup and sequence number translations to the server without modifying the kernel TCP stack, enabling immediate deployability. The server agent deploys an eBPF ingress and egress program attached to different kernel hooks (XDP and TC, respectively), performing connection setup with the kernel network stack and sequence number translations on incoming and outgoing packets (see § B. 2 for details). The eBPF programs act as a lightweight translation layer that converts custom packets received from the switch agent into proper TCP packets for regular TCP/IP processing by an unmodified kernel.

eBPF Map for Tracking State. eBPF maps can be used to communicate between user space and kernel space, and they are the only way to store and share state between eBPF programs. Maps are implemented as key-value stores, where values are defined by data type and size. The server agent uses an eBPF map to track the connection state of any given flow and to coordinate the behavior of the ingress and egress eBPF programs based on this state. The map key is the 4-tuple connection information (source and destination IP addresses and port numbers). The map value for each key stores the connection state of the connection and the sequence number delta to be applied for that connection. As shown in FIG. 3, the sequence number delta for a given connection is determined to be Δ=c−y, where c is the switch agent's original ISN (i.e., cookie value) and y is the ISN chosen by the kernel. At first, the server agent's ingress program extracts c from packet 4 and stores it in the eBPF map temporarily. Later, the server agent's egress program extracts y from packet 6 and then calculates and stores the true A in the eBPF map.

### Compact Data Structure at Switch Agent

To determine which packets require cookie checks, the switch agent (like any standard defense) must maintain a record of verified connections. In prior designs, the proxy keeps a local record of every verified connection that has passed the cookie check, using this record to remember the sequence number deltas that must be applied to all packets in the flow. This is an unattractive solution because it requires per-flow state, and memory is a limited commodity in high-speed switches.

Bloom Filters for Approximate State. Since SmartCookie offloads sequence number translations to the server agent, the switch agent can avoid keeping exact state by using a resource-efficient compact data structure called a Bloom filter. The Bloom filter can approximately keep track of clients that have passed the cookie check and successfully established a connection with the server. Bloom filters are efficient and powerful approximate data structures, but they come at the expense of a small number of false positives. There are no false negatives in Bloom filters, which is an important feature that ensures benign traffic is never blocked. It is noted the purpose of the Bloom filter is not to stop an adversary's non-SYN packets from reaching the server, although this does happen as a bonus. Instead, the goal of this design feature is to not keep per-flow state at the switch agent for verified flows, reducing strain on the memory-constrained switch.

Implementing Bloom Filters in the Switch Agent. To approximately track the set of benign TCP connections, this example uses register memory arrays on the Tofino programmable switch to implement a Bloom filter. Since the switch's pipeline only allows accessing one index per array when processing a packet, this example implements a Bloom filter variant called the Partitioned Bloom Filter (PBF). PBF splits its m-bit memory into k separate arrays M₁[·] . . . , Mₖ[·], each sized m/k, and uses k indexing hash functions h₁, . . . , hₖ:

$$ℱ \to [ \frac{m}{k} ]$$

to map the input key f∈ [symbol] (in this case, flow 4-tuple) into locations in the array. All arrays are initialized to zero. To insert a flow f, for each array i, one calculates the index hᵢ(f) and mark 1 in the corresponding index, i.e., Mᵢ[hᵢ(f)]←1. To query whether flow f has been added, one can check the same indices and report positive if they are all 1, i.e., Mᵢ[hᵢ(f)]==1, ∀i∈[k].

Automatically Cleaning the Bloom Filters. To prevent over-saturation and maintain the accuracy of the filters as time goes on, one can keep multiple Bloom filters at the switch agent in a rotating fashion, where at any given time window T_{W}, some filters are being written to, read from, or cleaned (i.e., emptied). A connection is considered active if any one of the Bloom filters reports a positive. For ongoing connections, one can add to the most recent filter whenever one sees the server sending a packet to the client; note that even for uni-directional upload traffic servers continuously send ACK packets to clients. Thus, when a filter is cleaned, ongoing connections automatically get carried over to the active filter.

We also note that T_{W} should be chosen such that one can maintain a reasonable timeout window that reflects the characteristics of the majority of connections in the network. A T_{W} value that is too small (e.g., a few seconds) will cause idling connections to be closed too early, while T_{W} values that are too large will require us to save too many active connections in the Bloom filter, causing increased memory usage and potentially higher false positive rates. Shorter T_{W} windows (also called “aggressive aging timeouts”) are the security best practice for preserving stability and performance while under attack, and can be as short as 10 seconds.

### Handling False Positives at Server Agent

The server agent cooperates with the switch agent to perform a last-line-of-defense cookie check on the small fraction of packets that experience a false positive in the Bloom filter.

Identifying False Positives. The server agent knows to perform this cookie check on any packets that are not already part of an ongoing connection at the server and do not have a setup tag from the switch agent. It is noted that SYN packets are always stopped and handled at the switch agent, so the server agent only handles benign traffic and non-SYN packets (either adversarial or benign) that have triggered a false positive in the Bloom filter. If the false positive was the result of an adversary's non-SYN packet (e.g., if the adversary was attempting to perform an ACK flood), it would fail the cookie check at the server agent and get dropped. However, if the false positive was triggered by a benign client (e.g., with the final ACK packet of the 3WHS between client and switch agent), then the packet would pass the cookie check at the server agent and the server agent would set up the connection with the kernel network stack.

Key Management. In existing SYN cookie defenses, only one party computes and verifies cookies. However, since both the switch and server agents verify cookies, they must share the same SYN cookie computation scheme so that cookies are consistent across the system. In other words, both switch and server agents must share the same hash functions and secret keys used to compute cookies; the network operator acts as the central controller for managing these keys across the system, installing the same initial key and performing periodic key rotation for both the switch and server agents. Furthermore, to ensure consistency when using timestamps to generate and verify cookies, SmartCookie relies on the network operator to synchronize clocks across the switch and server agents. It is also noted that on the server side, secret keys are only visible to the eBPF switch agent module and are not visible to applications or tenant VMs running on the server.

### Security Analysis

Possible attacks from adaptive adversaries against the example system itself (above and beyond an initial SYN-flooding attack vector) are discussed below, and it is explained how they can be addressed.

### Attacks on the Cookie Check

Replay Attacks. When a cookie is first computed at the switch, it is computed with respect to the current epoch of time. When cookies are recomputed and verified, they are only accepted if they are from the current or immediately preceding epoch. While the Linux kernel uses 1 minute epochs, we choose 1 second epochs instead, to reflect round-trip times (RTTs) commonly seen on the modern Internet. This ensures that SmartCookie only accepts cookies returned within acceptable RTT delays, while defending against replay attacks with older cookies. For consistency, the cloud provider deploying SmartCookie should ensure that clocks are synced (e.g., NTP) between the switch agent and the server agent.

Cookie Forging and Key Recovery. An adversary can send probe packets to the switch agent and observe the returned cookies in order to crack the hashing mechanism and forge her own cookies; formally, this is performing a Chosen Plaintext Attack (CPA) against the hash function. The security of SmartCookie against cookie forging can be directly reduced to the security of the underlying HalfSipHash family of hash functions. Assuming the security properties of HalfSipHash, the adversary cannot recover the key without a brute-force search. To make brute-forcing ineffective, SmartCookie rotate the key periodically (e.g., every 5-30 seconds). Thus, with the pseudorandom properties of HalfSipHash, the adversary's best attack strategy is reduced to simply guessing the cookie.

Lucky Cookies, and Saving TCP Options. The Linux kernel's default SYN cookie stores a quantized Maximum Segment Size (MSS) and discards all other TCP options. The disclosed switch agent similarly encodes the MSS in cookies, for the server agent to later decode. This approach leaves 24 bits of entropy in the cookie, meaning that each adversary's attack packet has a negligible probability (1/2²⁴) of “luckily” guessing the right cookie by chance. If desired, it is possible to use 3-4 more bits of the cookie to save a few more TCP options, in exchange for slightly reduced entropy.

### Attacks on the Bloom Filter

ACK Floods and TTL Expiry Attacks. The Bloom filter used by the disclosed switch agent to track verified connections has a small probability of reporting false positives; an adversary can send many ACK packets with randomized source IP addresses and port numbers, and a small fraction of these may trigger a false positive and be forwarded to the server. We refer to this as the ACK-flooding attack, and evaluate the performance of SmartCookie against such attacks in § 8. We note that these false positive ACK packets will be silently dropped by the server agent after failing its last-line-of-defense cookie check. We also filter TTLs of non-SYN packets that arrive at the switch agent, hiding from an adaptive adversary seeking to perform a TTL expiry attack whether her packets were dropped at the switch agent or at the server agent. This prevents the adversary from getting feedback on which attack packets successfully triggered false positives. Thus, she cannot tailor attack packets for the Bloom filter's internal structure to achieve a higher false positive rate.

Opening Many “Legitimate” TCP Connections. The false positive rate of Bloom filters depends on the number of connections inserted. In the threat model, adversaries have access to a moderate number of compromised devices to launch asymmetric SYN-flooding attacks, but not enough to mount successful symmetric attacks, such as TCP connection floods. Connection-flooding adversaries would need to establish many “legitimate” TCP connections to raise the Bloom filter's false positive rate before launching a SYN-flooding or ACK-flooding attack, requiring significant resources (e.g., machines, memory, packet processing). Nevertheless, we note these example filters are periodically cleaned and designed to achieve a reasonably low false positive rate under realistic traffic conditions. Even with high rates of Bloom filter pollution, SmartCookie still blocks 100% of SYN floods in the switch and is highly resilient under ACK floods.

### Evaluation

We evaluate SmartCookie by running several experiments on a hardware testbed. We 1) demonstrate the performance of SmartCookie for securely computing SYN cookies with HalfSipHash in the switch data plane, compared to other approaches, and 2) show the overall performance of SmartCOOKIE in comparison to Jaqen, the state-of-the-art switch-based SYN-flooding defense. We note that the authors own all testbed infrastructure, and attack traffic was only directed to dedicated testbed servers, raising no ethical issues.

### Experiment Setup

Prototype Implementation. SmartCookie's switch agent is implemented in P4 targeted for an Intel Tofino Wedge 10032BF programmable switch, with approximately 1000 lines of code. The server agent is implemented with eBPF. Prototypes of Jaqen SYN Cookie Proxy Mode 1 and Mode 2 are also run, based on source code obtained from the authors.

Testbed. The testbed consists of four servers and an Intel Tofino Wedge32X-BF programmable switch. Two machines act as adversaries, each with a 20-core Intel Xeon Silver 4114 CPU and a Mellanox ConnectX-5 2x100 Gbps NIC, generating attack traffic using DPDK 19.12.0 and pktgen-DPDK. Two other machines act as server and client, each with 8-core Intel Xeon D-1541 CPUs and Intel X552 2x10 Gbps NICs. All machines run Ubuntu 21.10 with kernel v5.13.0, and the eBPF programs are built with BCC v0.24.0 and Clang v13.0.0-2. The server machines are all connected to the switch via Direct Attach Copper (DAC) cables, with under 0.1 ms ping latency (round-trip time) between any pair of machines.

Setup: Realistic Traffic Load. To simulate a real-world setting with realistic benign traffic loads, we write customized client and server Go scripts to replay CAIDA anonymized Internet traffic trace 2018. We did not modify the Linux kernel's default TCP retransmission behavior.

Setup: Estimating the False Positive Rate. The example switch agent implementation uses Partitioned Bloom Filters with k=3 arrays of 2²⁰ bits each, with total memory size m=3×2²⁰ bits. For these experiments, a connection timeout window T_{W} of 15 seconds was chosen for Bloom filter cleaning, which reflects the default keepalive timeout of many applications. A 15-second trace window of benign traffic was chosen to match T_{W}, with n=579,600 flows. The trace represents heavier flow loads than the average from CAIDA trace statistics (386,000 flows over the same time window). Thus, one can generously estimate the false positive rate as:

$${F}_{p} ( n , m , i ) = {( 1 - {( 1 - \frac{k}{m} )}^{n} )}^{k} \approx 7.66 \% . \qquad ( 1 )$$

We replay each flow as an HTTP request in real time (approximately 38,500 requests per second), where the request starting time corresponds to the timestamp offset of the flow's first packet. We also measure the number of attack packets received at the server with this setup and verify that the measured false positive rate matches expectations. Meanwhile, since Jaqen's prototype uses a smaller Bloom filter (2¹⁶×4), we replay fewer flows (48,800) in Jaqen's experiments, such that the defense exhibits the same false positive rate of 7.66%. Since the number of connections in both experiments exceed the number of available ports, we add 65,536 IP addresses to both client and server; we use the connection 4-tuple as keys for Bloom filter lookups for both SmartCookie and Jaqen.

More generally, under different traffic conditions, time windows, and number of connections, we can use Equation 1 to estimate corresponding false positive rates. We also note that the example current implementation did not exhaust the memory available on the Tofino 1 switch, and we can build larger Bloom filters to support more connections, trading off more memory for a reduction in the false positive rate. Other switch models (e.g., Tofino 2) also provide more onboard memory to further increase Bloom filter size and lower false positive rates.

Setup: DDoS Attacks. We run pktgen-DPDK on the adversary machines to generate SYN floods with randomized source IPs and ports. Due to false positives, Jaqen will allow 7.66% of SYN-flooding traffic to reach the server and trigger a connection setup and kernel SYN cookie computation. Meanwhile, since the example switch agent handles 100% of SYN packets without passing any to the server, we run a separate experiment where we subject SmartCookie to ACK flood traffic, 7.66% of which will reach the server and trigger only eBPF SYN cookie verification at the server agent.

### Hashing Throughput

Under the experiment setup described above, we compare SmartCookie's performance against kernel-based SYN cookies and XDP-based cookies. Since prior work proposed running AES, a secure encryption algorithm, on Tofino switches, we also implement and benchmark a variant of SmartCookie switch agent using AES to compute cookies.

Measuring Throughput. We measure the maximum attack rate in Mpps each defense can handle before any packet loss. Since the benchmark performs one hash calculation per SYN packet, it effectively measures maximum hashing throughput.

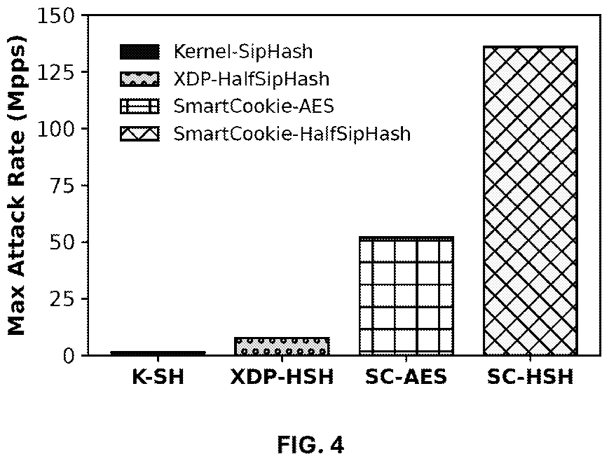

Results. As shown in FIG. 4, SmartCookieHalfSipHash significantly outperforms all other defenses, achieving a throughput of 136.9 Mpps on high-speed switch hardware. This is two orders of magnitude greater than the throughput achieved by the software-based kernel defense, which uses SipHash and can only serve 1.3 Mpps before the server's CPUs are exhausted. Using XDP to compute cookies can bypass the overhead of the kernel network stack and achieve 6× speedup (7.3 Mpps), but this is still much slower than SmartCookie-HalfSipHash. Meanwhile, although SmartCookie-AES is faster than XDP, it requires more recirculations and only achieves 52 Mpps; Smart-Cookie-HalfSipHash outperforms it by 2.6×.

We note that Tofino switches have dedicated recirculation ports, which operate without affecting capacity on other ports. The prototype switch agent achieves 136.9 Mpps using a single Tofino 1 switch under its vanilla setup (pre-configured ports with 200 Gbps recirculation throughput). To achieve even higher throughput, we can simply load balance between multiple switches to multiplex their throughput, or configure the switch to convert unused physical ports into extra recirculation bandwidth. For example, as a back-of-the-envelope calculation, using 20 recirculation ports, we could achieve 2Tbps recirculation throughput and serve roughly 1.4 billion requests per second. We also note that while repurposing additional ports for recirculation would reduce overall switch capacity, it will not affect latency. Finally, other switches exist (e.g., Tofino 2) with higher per-port throughput and more pipeline stages. Such switches, along with future hardware with native cryptographic support, can further reduce recirculation needs, additionally boosting throughput.

### Latency

In this experiment, we launch both benign and attack traffic against a server as described in § 8.1, and measure the end-to-end latency of benign application traffic while the server is under attacks of different magnitudes. We compare SmartCOOKIE against the vanilla kernel-based SYN cookie defense and Jaqen's two SYN proxy modes. SmartCookie's design is transparent to clients and does not cause connection reset, leading to 48%-84% lower latency than Jaqen.

Measuring Latency. We measure the end-to-end application latency by initiating HTTP requests from the client to the server, with response size of 14.5 KB (corresponding to the average flow size in the CAIDA anonymized Internet traffic trace 2018). For each attack rate, we send 30 requests and calculate the average latency. Since Jaqen's Proxy Mode 2 triggers an application-layer reset, most applications (curl, wget, etc.) will wait for at least one second before retrying the connection. This timeout is an unreasonably large penalty for benign clients, and so we write a customized Go client script that immediately retries after a reset, waiting for only 1 ms between connection attempts. This showcases the best possible performance of Jaqen, as it avoids the long default reset timeout, but we note that reconfiguring client applications is not always possible.

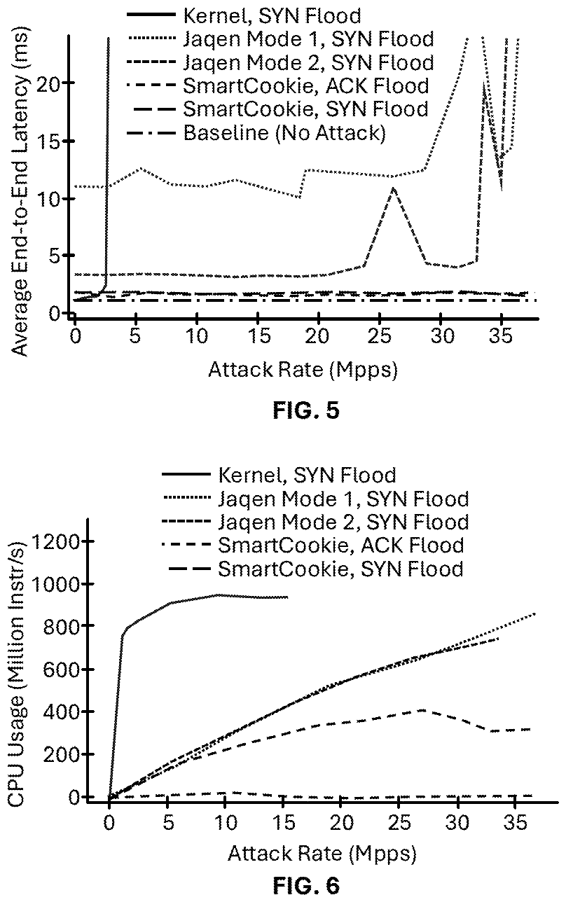

Results. As shown in FIG. 5, SmartCookie has consistently low end-to-end latency (1.71 ms), a 48%-84% reduction compared to Jaqen, even with the reconfigured fast retry client that bypasses Jaqen's default 1-second timeout. Jaqen Mode 1 incurs a reset and one additional round trip, with a minimum latency of 11.12 ms. Jaqen Mode 2 incurs two additional round trips and an application-layer retry, requiring at least 3.31 ms for end-to-end setup with the fast 1 ms retry client and over one second for default TCP applications that have not been reconfigured. Meanwhile, SmartCookie's latency, which is only 1.71 ms, is close to the baseline latency of the vanilla kernel without any attack (1.08 ms).

### Server CPU Usage

Using the same setup from § 8.1, we replay trace-based benign traffic while launching attack traffic at increasing rates. We measure the server's CPU overhead across various defenses. SmartCookie has no overhead for SYN floods and reduces overhead for ACK floods by 33-36% compared to Jaqen.

Measuring CPU. To measure CPU overhead, we use the perf stat command to read CPU performance counters and collect the number of instructions executed per second for each CPU core, taking the average across cores. We also repeat each measurement ten times and take this average. For more stable results, we turned off frequency scaling (Turbo Boost) and fixed all cores' frequency at 2.1 GHZ.

Results. Both modes of Jaqen exhibit similar server CPU overhead, as they both allow the same rate of false positive SYN packets to reach the server, where the defense degrades to SYN cookie computation on server software (FIG. 6). We note that SmartCookie switch agent processes 100% of SYN packets directly on network hardware, completely protecting server CPUs from resource exhaustion for SYN cookie computation. With SmartCookie, servers experience no CPU overhead during SYN floods. Thus, in order to see the effect of false positives on CPU usage with SmartCookie, we also measure the overhead of the server agent handling map lookup and cookie verification for false positive ACK packets: SmartCookie under an ACK flood exhibits approximately 33%-36% lower CPU overhead for the same attack rate and same false positive rate as Jaqen under a SYN flood. This is because Jaqen is a purely switch-based defense that degrades to the vanilla kernel's defense on false positives, which begins to suffer from attack rates as low as 1.3 Mpps. Meanwhile, SmartCookie is designed as a split-proxy system that cooperates with an XDP-based server agent for false positives. XDP operates on raw packets early in the kernel stack before any socket buffer is allocated, lowering the overhead significantly compared to the kernel defense.

### Switch Resource Usage & Compatibility

In Table 1 we report SmartCookie's utilization of switch hardware resources with two variants of hashes (HalfSipHash and AES), as reported by Intel's P4i tool. SmartCookie has a trivial footprint for important shared resources (TCAM:1.4%, SRAM: 6.8%). Notably, the HashUnit usage is highest (57%), but HashUnits are used less by other network functions. We also report resource utilization of Jaqen SYN Proxy (Modes 1 and 2), which use CRC as its cookie hash.

TABLE 1
Resource usage on programmable switch.

| | SRAM | TCAM | HashUnit | Instr. |
|---|---|---|---|---|
| Jaqen Mode 1 (CRC) | 4.6% | 0.0% | 19.4% | 4.9% |
| Jaqen Mode 2 (CRC) | 4.6% | 0.0% | 19.4% | 6.3% |
| SMARTCOOKIE-AES | 13.8% | 0.1% | 30.6% | 9.4% |
| SMARTCOOKIE-HSH | 6.8% | 1.4% | 56.9% | 9.9% |

Furthermore, we successfully integrated SmartCookieHalfSipHash into two feature-rich, complex P4 programs: tna_simple_switch.p4 and switch.p4, demonstrating SmartCookie can co-exist with other sophisticated network functions. Table 2 presents resource utilization metrics for each base program and the variant with SmartCookie added, highlighting SmartCookie's efficient footprint and compatibility with other switch functions.

TABLE 2
Adding SmartCookie to complex P4 programs.

| | SRAM | TCAM | HashUnit | Instr. |
|---|---|---|---|---|
| tna_simple_switch.p4 | 6.3% | 9.0% | 0.0% | 9.6% |
| +SmartCookie | 12.6% | 11.5% | 54.2% | 18.0% |
| switch.p4 | 33.6% | 31.6% | 19.4% | 13.5% |
| +SMARTCOOKIE | 40.1% | 37.5% | 73.6% | 20.3% |

### DISCUSSION

Routing Considerations. We envision the defense deployed in a provider network with multiple edge switches, motivating the need to be robust to both asymmetric routing and potential routing changes. SmartCookie handles asymmetric routing by default with several clever design decisions, and it can handle routing changes using two high-level approaches, each with their own tradeoffs. Cooperating switch agents can maintain synchronized Bloom filters with state for all verified connections. Alternatively, Bloom filters across individual switch agents can dynamically adapt to routing changes using a packet sampling approach. Please see § C for more details.

Serving Tenants Transparently. SmartCookie does not modify the server's network stack, and can serve unmodified tenant VMs running on servers. From the tenant's point of view, the TCP protocol is unchanged. Today's high performance VM hypervisors and container hosts often run specialized software switches (e.g., eBPF-based Cilium) to handle tenant traffic, and SmartCookie's server agent can be integrated into these software switches.

Handling Other DDoS Attacks. Although SmartCookie was explicitly designed for large-scale SYN-flooding attacks, by default it also handles other TCP-based volumetric attacks (e.g., ACK floods, SYN-ACK floods, RST/FIN floods), quickly dropping attack traffic on behalf of the server. It is believed the disclosed design can also be generalized to UDP-based volumetric attacks, with mechanisms like those proposed in.

A number of implementations have been described. Nevertheless, it will be understood that various modifications may be made without departing from the spirit and scope of the disclosure. Accordingly, other implementations are within the scope of the following claims.

1. A method for defending large-scale volumetric attacks in a scalable and performant manner, comprising:
on a first programmable target, performing a cookie check securely, and tracking verified connections approximately, the first programmable target operably coupling an unsecure network to a backbone network; and
on a device on the backbone network, using a second programmable target for handling benign connections, conducting sequence number translations, and exactly tracking verified connections.

2. The method of claim 1, wherein the first programmable target is a programmable switch.

3. The method of claim 1, wherein the second programmable target is an extended Berkeley Packet Filter (eBPF) kernel optimizations, Smart NIC, or FPGA NIC.

4. The method of claim 1, wherein the large-scale volumetric attacks include distributed denial-of-service (DDoS) attacks.

5. The method of claim 4, wherein the DDoS attacks are SYN flooding attacks.

6. The method of claim 1, wherein the large-scale volumetric attacks include TCP-based attacks.

7. The method of claim 1, further comprising directly forwarding, without buffering, a final ACK packet of a TCP three-way handshake to the device on the backbone network, where the TCP three-way handshake is between a client and the first programmable target.

8. The method of claim 7, wherein forwarding the final ACK packet includes sending an additional setup tag in a setup packet to notify the device on the backbone network to bootstrap a connection setup.

9. The method of claim 8, wherein the setup packet also instructs the device on the backbone network how to handle a difference in initial sequence numbers (ISNs) chosen by the first programmable target and a network stack of the device on the backbone network.

10. The method of claim 1, wherein the device on the backbone network is a server.

11. The method of claim 1, wherein tracking verified connections approximately includes using a Bloom filter to approximately keep track of clients that have passed the cookie check and successfully established a connection with the device on the backbone network.

12. The method of claim 1, wherein the device on the backbone network deploys an eBPF ingress and egress program attached to different kernel hooks performing connection setup with a kernel network stack and sequence number translations on incoming and outgoing packets, using eBPF maps.

13. A system for defending large-scale volumetric attacks in a scalable and performant manner, comprising:
a switch agent deployed on a first programmable target deployed in a core network of an internet service provider (ISP), the switch agent configured to perform a cookie check securely, and track verified connections approximately; and
a server agent deployed on a server on the core network, the server agent configured to, using a second programmable target, handle benign connections, conduct sequence number translations, and exactly track verified connections.

14. The system of claim 13, wherein the first programmable target is a programmable switch.

15. The system of claim 13, wherein the second programmable target is an extended Berkeley Packet Filter (eBPF) kernel optimizations, Smart NIC, or FPGA NIC.

16. The system of claim 13, wherein the server agent is deployed on a network interface card (NIC) or on a processing unit of a server.

17. The system of claim 13, further comprising one or more verified clients communicating with the server agent through the switch agent to communicate with an application running on the server wherein the server agent is deployed on a network interface card (NIC) or on a processing unit of a server.
